(19) United States
(12) Patent Application Publication
(10) Pub. No.: US 2015/0095603 A1
(43) Pub. Date: Apr. 2, 2015

(54) METHOD AND DEVICE FOR CLEARING PROCESS IN ELECTRONIC DEVICE

(71) Applicant: Samsung Electronics Co., Ltd., Suwon-si (KR)

(72) Inventors: Hakryoul KIM, Seongnam-si (KR); Hua LIU, Jiangsu (CN); Yingbo PAN, Jiangsu (CN); Moonkwang LEE, Suwon-si (KR)

(21) Appl. No.: 14/497,872

(22) Filed: Sep. 26, 2014

(30) Foreign Application Priority Data
Sep. 30, 2013 (CN) 201310461655.4
Apr. 21, 2014 (KR) 10-2014-0047302

(51) Int. Cl. G06F 9/30; G06F 12/02

(52) U.S. Cl. CPC G06F 9/30043; G06F 12/023; G06F 2212/1036
USPC 711/166

(57) ABSTRACT

A method and a device for clearing a process in an electronic device are provided. The method includes calculating an amount of memory allocated for a preset time period when a memory application is requested, predicting an amount of memory to be allocated for a future setting time period based on the amount of the memory, and selecting and clearing at least one of present processes based on the amount of the memory to be allocated. Accordingly, sufficient memory can be obtained in a short period of time by recalling a plurality of processes. In this way, the electronic device can continuously allocate an abundance of memory.

### CROSS-REFERENCE TO RELATED APPLICATION(S)

This application claims the benefit under 35 U.S.C. §119(a) of a Chinese patent application filed on Sep. 30, 2013 in the State Intellectual Property Office and assigned Serial number 201310461655.4, and a Korean patent application filed on Apr. 21, 2014 in the Korean Intellectual Property Office and assigned Serial number 10-2014-0047302, the entire disclosure of each of which is hereby incorporated by reference.

### TECHNICAL FIELD

The present disclosure relates to a method and a device for clearing a process in an electronic device.

### BACKGROUND

An electronic device can control a life cycle of a process. When a user executes a program and then terminates the program, or changes the program to another program, the process of the corresponding program may still reside in the memory of the electronic device. This helps the electronic device process a quick launch of the program by the process residing in the memory when next executing the program. However, the process processing method may increase the running time of the electronic device, and may increasingly reduce the residual memory of the electronic device.

Accordingly, the electronic device supports memory management, and can generally control the memory using a memory killer. When the memory in use is insufficient, the electronic device may kill some unnecessary processes, which are residing in the memory, through the memory killer. Thus, the electronic device can address the deficiency in memory.

The electronic device can grant a grade (e.g., priority) to each process by the complex scoring mechanism using the memory killer, select the process having the highest grade, namely, the process having the lowest priority (e.g., select the process occupying the largest amount of memory when the processes have an identical priority), and kill the selected process in the memory. In the electronic device, the process management may be performed by the memory killer when memory allocation fails.

FIG. 1 is a flowchart illustrating a procedure of clearing memory in an electronic device according to the related art.

Referring to FIG. 1, the electronic device may periodically check the memory to determine whether the present idle memory is insufficient in operation 101. For example, the electronic device may compare the amount of the present idle memory with a preset threshold value to determine the amount of the present idle memory.

When it is determined in operation 101 that the present idle memory is smaller than the threshold value (namely, the memory is insufficient), the electronic device may search processes of the memory based on the priority, and may calculate the amount of the memory accommodated by the processes in operation 103. In general, the importance value of the processes residing in the memory may be determined based on the priority of the processes. The priority of the processes may be related to the order scheduling and the type of processes.

The electronic device may determine the processes having a priority higher than the reference priority in operation 105. The electronic device may select the process having the highest priority among the determined processes to kill it. The electronic device, when a plurality of processes is selected, may determine the priority of the processes in operation 107. When it is determined that the plurality of processes has the same priority, the electronic device may select the process occupying the largest amount of memory in operation 109. The electronic device may kill the selected process in the memory in operation 111.

The process processing method according to the related art kills (e.g., terminates) only one process at each time (e.g., at the time of the periodic check) and, therefore, does not correspond to the requirements for the continuous high memory allocation of the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for more efficiently clearing a process.

Another aspect of the present disclosure is to provide a method and a device which can recall a plurality of processes in a short period of time in order to secure sufficient memory, thereby continuously maintaining the allocation of an abundance of memory in the electronic device.

In accordance with one aspect of the present disclosure, a method of clearing a process is provided. The method includes calculating an amount of memory allocated for a preset time period, when a memory application is requested, predicting an amount of memory to be allocated for a future setting time period based on the amount of the memory, and selecting and clearing at least one of present processes based on the amount of the memory to be allocated.

In accordance with another aspect of the present disclosure, a device for clearing a process is provided. The device includes a memory calculating module configured to calculate an amount of memory allocated for a preset time period when a memory application is requested, a memory predicting module configured to predict an amount of memory to be allocated for a future setting time period based on the amount of the allocated memory calculated by the memory calculating module, and a process clearing module configured to select and clear at least one of all present processes based on the amount of the memory to be allocated.

According to the various embodiments of the present disclosure, more idle memory can be obtained to correspond to the calculated amount of the memory, by calculating the amount of the memory allocated for the preset time period, predicting the amount of the memory to be allocated for the future setting time period based on the amount of the allocated memory, and selecting and clearing the arbitrary processes in the system based on the amount of the memory to be allocated. Accordingly, sufficient memory can be obtained in a short period of time by recalling a plurality of processes. In this way, requirements for continuously allocating much memory can be satisfied in the system.

In addition, according to the various embodiments of the present disclosure, as compared with the existing process clearing method, the number of processes unnecessarily killed by the system can be decreased, and the amount of the memory used by the system can be efficiently managed. Furthermore, in the various embodiments of the present disclosure, any significant negative influence is not exerted on other performance indices of a platform.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating a procedure of clearing memory in an electronic device according to the related art;

FIG. 2 is a block diagram illustrating a network environment including an electronic device according to an embodiment of the present disclosure;

FIG. 3 is a block diagram schematically illustrating a configuration of a memory control module of an electronic device according to an embodiment of the present disclosure;

FIG. 4 is a flowchart illustrating a method of clearing a process in an electronic device according to an embodiment of the present disclosure;

FIG. 5 is a flowchart illustrating a method of calculating an amount of memory in order to clear a process in an electronic device according to an embodiment of the present disclosure;

FIGS. 6A and 6B are flowcharts illustrating a method of clearing a process using a process list to be cleared in an electronic device according to an embodiment of the present disclosure; and

FIG. 7 is a block diagram of an electronic device according to an embodiment of the present disclosure.

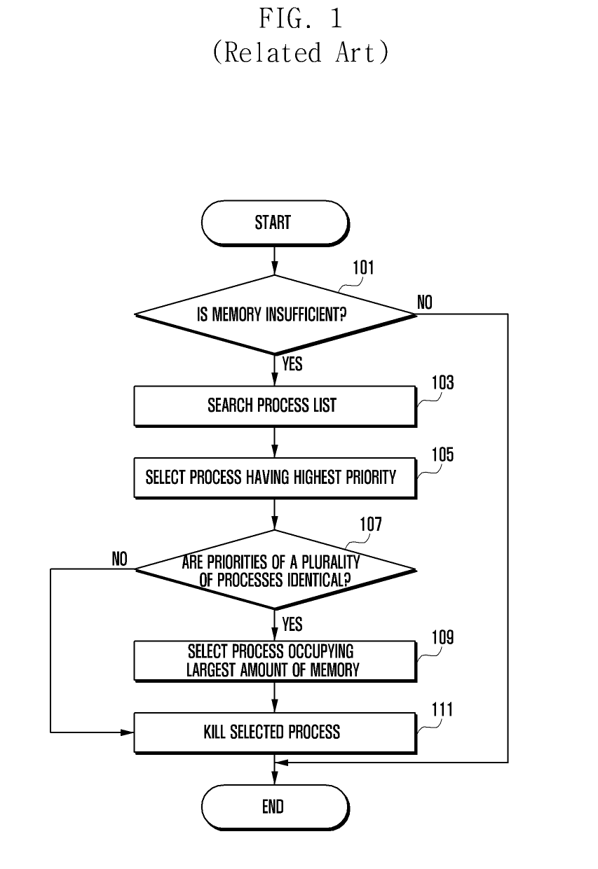

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions that may be used in various embodiments of the present disclosure, such as, “comprise”, “may comprise” or the like indicates the existence of a disclosed corresponding function, operation, component element, or the like, and may not limit additional one or more functions, operations, component elements or the like. Further, it should be understood that the terms “include” or “have” in various embodiments of the present disclosure refer to the presence of features, numbers, steps, operations, elements or components or a combination thereof, which are described in the specification, and do not rule out the presence or the addition of features, numbers, steps, operations, elements or components or a combination thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of various embodiments but does not limit the corresponding components. For example, the above expressions do not limit the sequence and/or importance of the elements. The above expressions may be used merely for the purpose to distinguish a constituent element from other constituent elements. For example, a first user device and a second user device indicate different user devices although both of them are user devices. For example, without departing from the scope of the present disclosure, a first structural element may be named a second structural named. Similarly, the second structural element also may be named the first structural element.

When a component is referred to as being “connected” or “accessed” to any other component, it should be understood that the component may be directly connected or accessed to the other component, but another new component may also be interposed between them. Contrarily, when a component is referred to as being “directly connected” or “directly accessed” to any other component, it should be understood that there is no new component between the component and the other component.

The terms used in various embodiments of the present disclosure are merely used to exemplify a certain embodiment and should not limit various embodiments of the present disclosure. Singular forms are intended to include plural forms unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Electronic devices according to various embodiments of the present disclosure may be devices adopting a communication function. For example, the electronic device may include at least one of a smart phone, a tablet Personal Computer (PC), a mobile phone, a video telephone, an e-book reader, a desktop PC, a laptop PC, a netbook computer, a Personal Digital Assistant (PDA), a Portable Multimedia Player (PMP), a digital audio player, a mobile medical appliance, a camera, a game machine, and a wearable device (e.g., a Head-Mounted-Device (HMD) such as electronic glasses, electronic clothing, an electronic bracelet, an electronic necklace, an electronic appcessory, an electronic tattoo, and a smart watch).

According to another embodiment, the electronic devices may be smart home appliances adopting a communication function. The smart home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a TV box (for example, Samsung HomeSync™, Apple TV™, or Google TV™), a game console, an electronic dictionary, an electronic key, a camcorder, and an electronic picture frame.

According to some various embodiments, the electronic device may include at least one of various medical appliances (e.g. Magnetic Resonance Angiography (MRA), Magnetic Resonance Imaging (MRI), Computed Tomography (CT) machine, and an ultrasonic machine), navigation devices, Global Positioning System (GPS) receivers, Event Data Recorders (EDRs), Flight Data Recorders (FDRs), automotive infortainment devices, electronic equipments for ships (e.g., navigation equipments for ships, gyrocompasses, or the like), avionics, security devices, head units for vehicles, industrial or home robots, Automatic Teller Machines (ATM) of banking facilities, and Point Of Sales (POSs) of shops.

According to another embodiment, the electronic devices may include at least one of furniture or a part of a building/structure having a communication function, electronic boards, electronic signature receiving devices, projectors, or various measuring equipment (e.g., equipment for a water supply, an electricity, gases or radio waves). Electronic devices according to various embodiments of the present disclosure may be one or more combinations of the above-described devices. In addition, electronic devices according to various embodiments of the present disclosure may be flexible devices. Further, it is obvious to those skilled in the art that electronic devices according to various embodiments of the present disclosure are not limited to the above-described devices.

Hereinafter, an electronic device according to various embodiments of the present disclosure will be described with reference to the accompanying drawings in order to further clarify objectives, technical solutions, and effects of the present disclosure. The term “a user” used in various embodiments may refer to a person who uses electronic devices or a device (e.g., an artificial intelligence electronic device) that uses electronic devices.

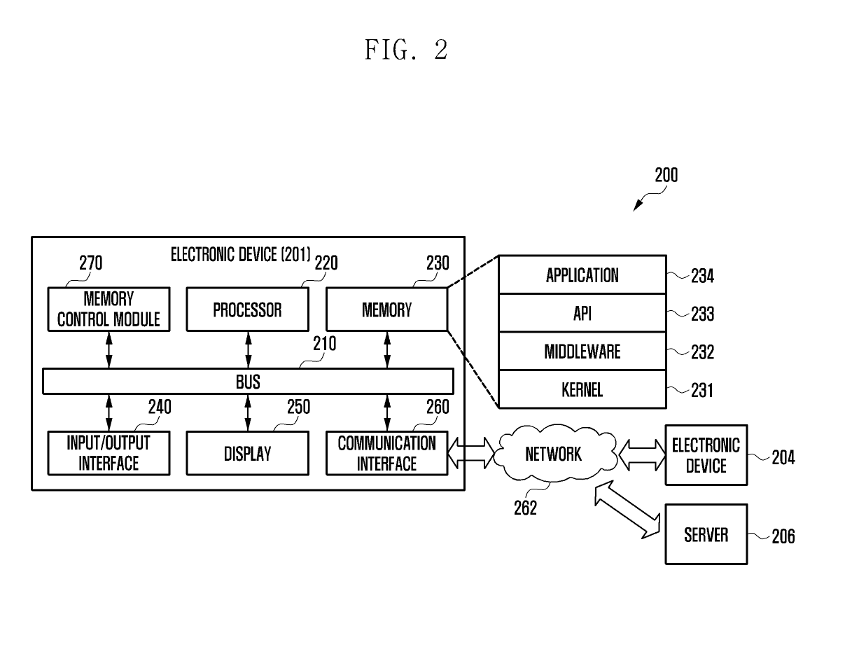

FIG. 2 is a block diagram illustrating a network environment 200 including an electronic device 201 according to an embodiment of the present disclosure.

Referring to FIG. 2, the electronic device 201 may include a bus 210, a processor 220, a memory 230, an input/output interface 240, a display 250, a communication interface 260, a memory control module 270 and other similar and/or suitable components. The bus 210 may be a circuit connecting the aforementioned elements and communicating data (e.g., a control message) between the aforementioned elements.

For example, the processor 220 may receive instructions from the aforementioned other elements (e.g., the memory 230, the input/output interface 240, the display 250, the communication interface 260, and the memory control module 270) through the bus 210, decipher the received instructions, and perform prediction or data processing according to the deciphered instructions.

The memory 230 may store instructions or data received from or created by the processor 220 or the other elements (e.g., the input/output interface 240, the display 250, the communication interface 260, and the memory control module 270). The memory 230 may include programming modules, for example, a kernel 231, middleware 232, an Application Programming Interface (API) 233, applications 234, and other suitable and/or similar programming modules. Each of the programming modules described above may be configured by software, firmware, hardware, or combinations of two or more thereof.

The kernel 231 may control or manage system resources (e.g., the bus 210, the processor 220, or the memory 230) used for executing an operation or function implemented in the remaining other programming modules, for example, the middleware 232, the API 233, or the applications 234. Furthermore, the kernel 231 may provide an interface through which the middleware 232, the API 233, or the applications 234 may access individual elements of the electronic device 201 to control or manage the elements.

The middleware 232 may perform a relay function of allowing the API 233 or the applications 234 to exchange data by communicating with the kernel 231. Furthermore, in regard to task requests received from the applications 234, the middleware 232 may perform a control (e.g., scheduling or load balancing) for the task requests using, for example, a method of assigning a priority for using the system resources (e.g., the bus 210, the processor 220, and the memory 230) of the electronic device 201 to at least one of the applications 234.

The API 233 is an interface through which the applications 234 may control functions provided by the kernel 231 and the middleware 232, and may include at least one interface or function (e.g., instruction) for file control, window control, image processing, or text control.

According to various embodiments, the applications 234 may include a Short Message Service (SMS)/Multimedia Message Service (MMS) application, an e-mail application, a calendar application, an alarm application, a health care application (e.g., an application for measuring an amount of exercise or blood sugar), and an environmental information application (e.g., an application for providing an atmospheric pressure, humidity, temperature, and the like). Additionally or alternately, the applications 234 may include an application related to an information exchange between the electronic device 201 and an external electronic device (e.g., an electronic device 204). The application associated with the information exchange may include, for example, a notification relay application for transferring specific information to the external electronic device or a device management application for managing the external electronic device.

For example, the notification relay application may include a function of transferring, to the external electronic device (e.g., the electronic device 204), notification information generated from other applications of the electronic device 201 (e.g., an SMS/MMS application, an e-mail application, a health management application, an environmental information application, and the like). Additionally or alternatively, the notification relay application may receive the notification information from, for example, the external electronic device (e.g., the electronic device 204), and may provide the received notification information to a user. The device management application may manage (e.g., install, delete, or update), for example, a function for at least a part of the external electronic device (e.g., the electronic device 204) communicating with the electronic device 201 (e.g., turning on/off the external electronic device itself (or some elements thereof) or adjusting brightness (or resolution) of a display), applications operating in the external electronic device, or services provided from the external electronic device (e.g., a telephone call service or a message service).

According to various embodiments, the applications 234 may include an application set on the basis of an attribute (e.g., a type) of the external electronic device (e.g., the electronic device 204). For example, in a case where the external electronic device is a digital audio player, the applications 234 may include an application related to reproduction of music. Similarly, in a case where the external electronic device is a mobile medical appliance, the applications 234 may include an application related to health care. According to an embodiment, the applications 234 may include at least one of an application designated to the electronic device 201 and an application received from the external electronic device (e.g., the electronic device 204).

The input/output interface 240 may transfer instructions or data input from a user through an input/output device (e.g., a sensor, a keyboard, or a touch screen) to, for example, the processor 220, the memory 230, the communication interface 260, or the memory control module 270 through the bus 210. For example, the input/output interface 240 may provide, to the processor 220, data for a user's touch input through the touch screen. Furthermore, through the input/output device (e.g., a speaker or a display), the input/output interface 240 may output instructions or data received from the processor 220, the memory 230, the communication interface 260, or the memory control module 270 through the bus 210. For example, through the speaker, the input/output interface 240 may output voice data processed through the processor 220 to a user. The display 250 may display various pieces of information (e.g., multimedia data or text data) to a user.

The communication interface 260 may connect communication between the electronic device 201 and the external electronic device (e.g., the electronic device 204). For example, the communication interface 260 may be connected to a network 262 through wireless or wired communication to communicate with the external device. The wireless communication may include at least one of, for example, Wi-Fi, Bluetooth (BT), Near Field Communication (NFC), Global Positioning System (GPS) and cellular communication (e.g., Long Term Evolution (LTE), LTE-A, Code Division Multiple Access (CDMA), Wideband CDMA (WCDMA), Universal Mobile Telecommunication System (UMTS), Wireless Broadband (WiBro), Global System for Mobile communication (GSM), or the like). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 262 may be a telecommunication network. The telecommunication network may include at least one of a computer network, the Internet, the Internet of things, and a telephone network. According to an embodiment, a protocol (e.g., a transport layer protocol, data link layer protocol, or a physical layer protocol) for communication between the electronic device 201 and the external device may be supported by at least one of the applications 234, the Application Programming Interface (API) 233, the middleware 232, the kernel 231, and the communication interface 260.

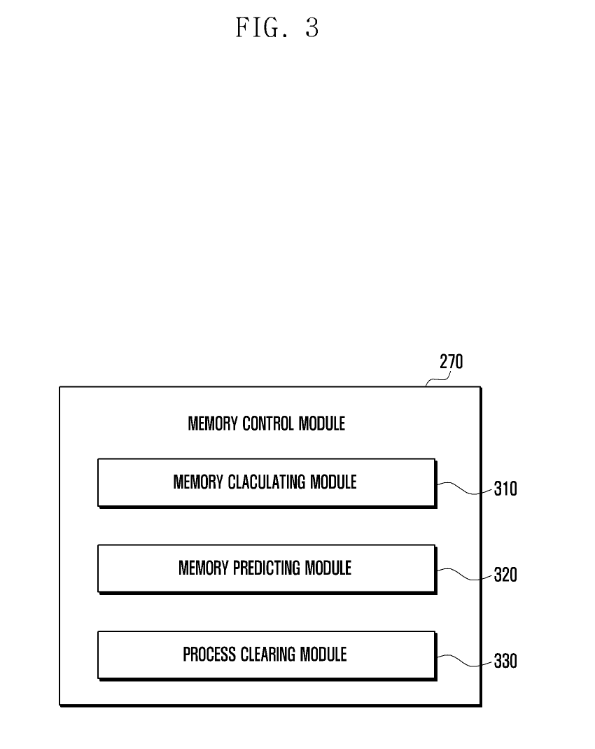

The memory control module 270 may process at least some pieces of information acquired from the other elements (e.g., the processor 220, the memory 230, the input/output interface 240, and the communication interface 260), and may provide the processed information to a user through various methods. For example, the memory control module 270 may control at least some functions of the electronic device 201 using or independently of the processor 220 such that the electronic device 201 operates in conjunction with the other electronic device (e.g., the electronic device 204). Additional information on the memory control module 270 may be provided through FIGS. 3 to 6B.

FIG. 3 is a block diagram schematically illustrating a configuration of a memory control module of an electronic device according to an embodiment of the present disclosure.

Referring to FIG. 3, the memory control module 270 may include a memory calculating module 310, a memory predicting module 320, and a process clearing module 330.

The memory calculating module 310, when a memory application is requested, may calculate an amount of memory allocated for a preset time period.

The memory predicting module 320, when the present idle memory is smaller than a set threshold value, may predict an amount of memory which will be allocated for a future setting time period, based on the amount of the allocated memory which has been calculated by the memory calculating module.

The process clearing module 330 may select at least one of all the present processes based on the amount of the allocable memory which has been predicted by the memory predicting module, add at least one process to a process list to be cleared, and clear all processes from the process list to be cleared, thereby obtaining idle memory corresponding to the amount of the memory to be allocated.

The memory calculating module 310 calculates the amount of the memory, which has been allocated for the preset time period, through the following steps.

According to the cycle counting method, the memory calculating module 310 may calculate an amount of memory first allocated for a recent setting time period and, when detecting that the memory has not been allocated for at least one time period in the recent setting time period, may configure the time period in the recent setting time period in which the memory has not been allocated as a present time period, and the recent setting time period as a present setting time period. Here, the recent setting time period may be a past setting time period.

Furthermore, the memory calculating module 310 may exclude the present time period from the present setting time period, and may replace the present time period of the present setting time period by a recent time period. Here, the recent time period may have the same size as the present time period, and may be a time period in which memory has been allocated according to a set frequency selected from a time period prior to the present setting time period. The memory calculating module 310 may determine a presence or absence of the time period in which the memory calculating module 310 has not been allocated for the recent setting time period. Through the following steps, the memory predicting module 320 may predict the amount of the memory to be allocated for the future setting time period based on the amount of the allocated memory which has been calculated by the memory calculating module 310.

That is, the amount of the memory to be allocated for the future setting time period may be predicted based on the amount of the allocated memory according to a linear or non-linear prediction manner.

In the embodiment of the present disclosure, the process clearing module 330 may select at least one of all the present processes based on the amount of the memory to be allocated, and may add the at least one process to the process list to be cleared.

The process clearing module 330 may search all the present processes in order to select processes having the lowest priority based on the calculated amount of the memory.

Thereafter, the process clearing module 330 may select the processes having the lowest priority by determining the priority of the present processes. The process clearing module 330 may determine the number of selected processes having the lowest priority, and if the number of processes having the lowest priority is larger than 1, may select the processes having the lowest priority depending on the amount of the memory. The process clearing module 330 may select a process occupying the maximum amount of the memory. If not (namely, if the number of selected processes is smaller than or equal to 1), the process clearing module 330 may directly configure (e.g., select) a process having the lowest priority.

Thereafter, the process clearing module 330 may determine whether the number of selected processes reaches a set process upper threshold value. If so, the process clearing module 330 may add the selected processes to the process list to be cleared, and may terminate the current operation flow. In contrast, if not, the process clearing module 330 may determine whether the amount of memory accommodated by the selected processes corresponds to the predicted amount of the memory. If so, the process clearing module 330 may add the selected processes to the process list to be cleared. In contrast, if not, the process clearing module 330 may search processes other than the selected processes among all the present processes in order to select a process having the lowest priority.

According to the embodiment of the present disclosure, the process clearing module 330 may obtain the idle memory corresponding to the amount of the allocated memory as follows, by clearing all the processes from the process list to be cleared.

The idle memory corresponding to the amount of the memory may be obtained by killing, at one time, all the processes in the process list to be cleared, and releasing the amount of the memory accommodated by the killed processes such that it corresponds to the predicted amount of the memory.

The process clearing module 330, after killing all the processes in the process list to be cleared at one time, additionally clears all the processes recorded in the process list to be cleared.

The device for clearing the memory as described above may include the memory calculating module that calculates the amount of the memory allocated for the preset time period when the memory application is requested; the memory predicting module that predicts the amount of the memory to be allocated for the future setting time period, based on the amount of the allocated memory calculated by the memory calculating module; and the process clearing module that selects and clears at least one of all the present processes based on the amount of the memory to be allocated. As can be seen from the above-described technical solution, in the present disclosure, more idle memory can be obtained to correspond to the predicted amount of the memory, by calculating the amount of the memory allocated for the preset time period, predicting the amount of the memory to be allocated for the future setting time period based on the amount of the allocated memory, and selecting and clearing the arbitrary processes in the system based on the amount of the memory to be allocated. Accordingly, sufficient memory can be obtained in a short period of time by recalling a plurality of processes. In this way, requirements for continuously allocating much memory are satisfied in the system.

In addition, as compared with the existing process clearing method, the number of processes killed by the system can be considerably decreased, and the memory used by the system can be efficiently managed, by using the present disclosure under the same condition. Furthermore, the present disclosure does not exert any significant negative influence on other performance indices of a platform.

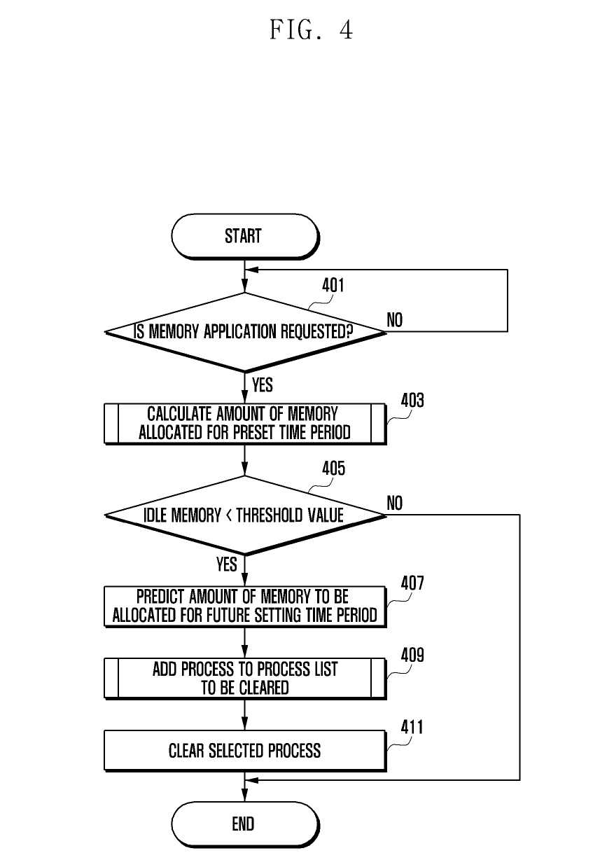

FIG. 4 is a flowchart illustrating a method of clearing a process in an electronic device according to an embodiment of the present disclosure.

Referring to FIG. 4, a memory calculating module 310 may determine whether a memory application is requested in operation 401. When the memory application is requested, the memory calculating module 310 may calculate an amount of memory allocated for a preset time period in operation 403.

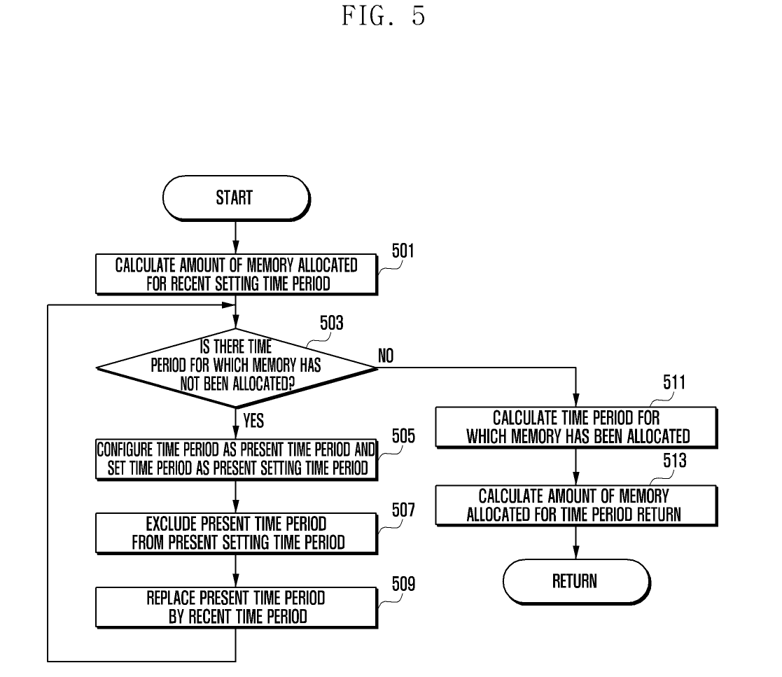

In general, when a specific process is to be initiated, a memory application to commence the process may be requested (e.g., memory allocation may be requested). Accordingly, the memory calculating module 310, when the new memory application is requested, may calculate the amount of the memory allocated for the preset time period in operation 403. The operation in which the memory calculating module 310 according to various embodiments of the present disclosure, calculates the amount of the memory allocated for the preset time period will be described with reference to FIG. 5.

FIG. 5 is a flowchart illustrating a method of calculating an amount of memory in order to clear a process in an electronic device according to an embodiment of the present disclosure. The memory calculating module 310, when calculating the amount of the memory, may perform the following steps according to the cycle counting method.

The memory calculating module 310 may calculate an amount of memory first allocated for a recent setting time period in operation 501. Thereafter, the memory calculating module 310 may determine a presence or absence of at least one time period in the recent setting time period for which the memory has not been allocated in operation 503. In the case where there is the time period for which the memory has not been allocated, the memory calculating module 310 may configure the time period in the recent setting time period for which the memory has not been allocated as a present time period, and the recent setting time period as a preset setting time period in operation 505.

The memory calculating module 310 may exclude the present time period from the present setting time period in operation 507, and may replace the present time period of the present setting time period by a recent time period in operation 509. Here, the recent time period may have the same size as the present time period, and may be a time period in which memory is allocated from a time period prior to the present setting time period. Then, the memory calculating module 310 may return to operation 503 to determine whether the recent setting time period for which the memory has not been allocated still exists. Meanwhile, in the case where the time period for which the memory has not been allocated does not exist as a result of the determination in operation 503, the memory calculating module 310 may calculate a time period in the recent setting time period for which the memory has been allocated, in operation 511. The memory calculating module 310 may calculate the amount of the memory allocated for the time period in operation 513, and the operation flow may return to FIG. 4.

According to an embodiment, in a case where the set time period is one minute, and the memory is allocated once per 5 seconds within one minute, when the memory application is requested, the amount of the memory allocated for the last one minute is calculated. If it is identified that the memory has not been allocated once per five seconds for the first twenty seconds within the last one minute, and has been allocated once per five seconds for the remaining forty seconds, the amount of the memory allocated for the first twenty seconds within the last one minute is calculated. If it is identified that the memory has not been allocated once per five seconds for these twenty seconds, the amount of the memory in these twenty seconds and the previously calculated amount of the memory in the forty seconds may be configured as the amount of the memory in one minute.

Thereafter, the memory predicting module 320 may determine whether the present idle memory is smaller than the set threshold value in operation 405.

When the present idle memory is larger than or equal to the set threshold value, it means that the idle memory does not correspond to the memory application request, the operation of killing the operating process, according to the present disclosure, does not need to be performed, and the obtained memory application request may also be processed according to the existing memory allocating method.

Meanwhile, when the idle memory is smaller than the set threshold value, the memory predicting module 320 may predict an amount of memory to be allocated for a future setting time period in operation 407. Here, the future setting time period is a time period after the present time.

The memory predicting module 320 may predict the amount of the memory to be allocated for the future setting time period based on the amount of memory allocated according to a linear or non-linear prediction manner.

It is assumed that the set time period is m in operation 403, and the future setting time period is n in operation 407.

For example, in the linear prediction manner, if the amount of the memory allocated for the time period m calculated in operation 403 is k, the amount of the memory to be allocated for the future setting time period n may be predicted by Equation 1 below.

Amount of Memory=k/m*n Equation 1

In the nonlinear prediction manner, if the set time period m is divided into p segments (p is an integer number larger than zero), amounts of memory allocated to the respective segments of the time period are k1, k2, . . . , and kp, and weighting factors of the respective segments of the time period are w1, w2, . . . , and wp, the amount of the memory to be allocated for the future setting time period n may be predicted by Equation 2 below.

Amount of Memory=(k1*w1+k2*w2+ . . . +kp*wp)/m*n Equation 2

It should be noted that the linear or non-linear prediction manner is used to predict the amount of the memory to be allocated for the future setting time period. However, the present disclosure is not limited thereto, and any prediction method may be used to predict the amount of the memory to be allocated for the future setting time period in the present disclosure.

The process clearing module 330 may select and clear at least one of all the present processes based on the amount of the memory to be allocated.

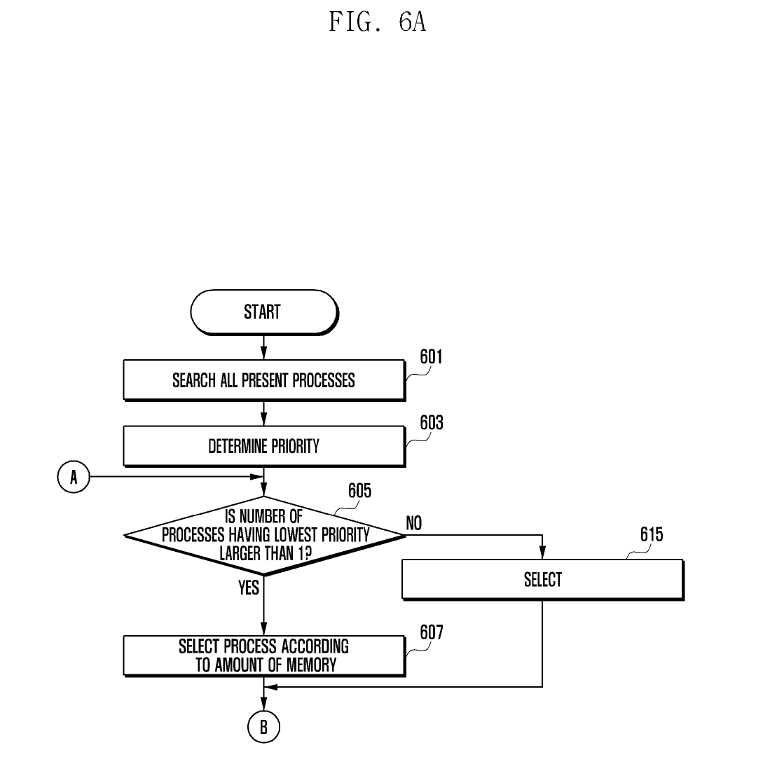

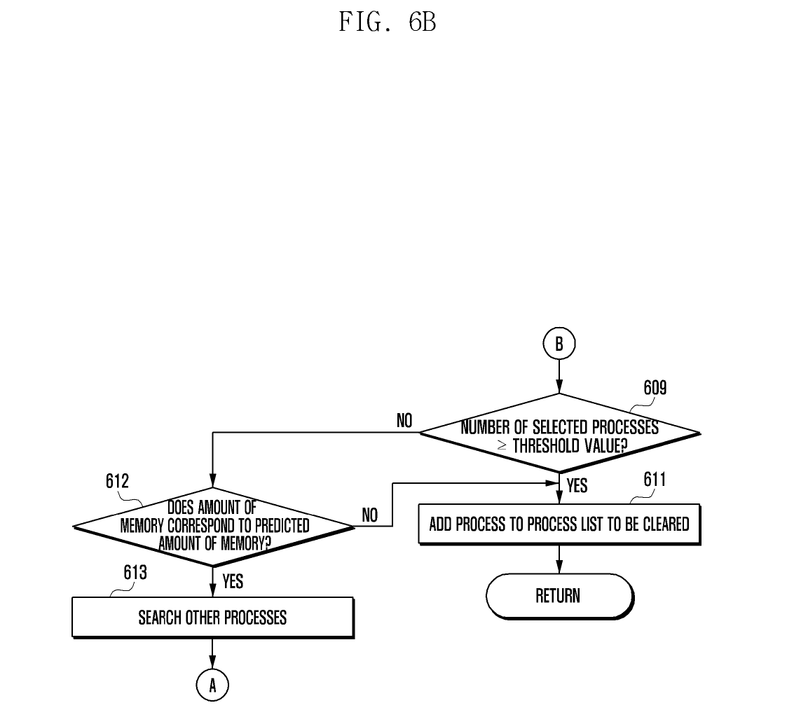

The process clearing module 330 may select at least one of all the present processes based on the amount of the memory to be allocated in operation 409, and may clear the selected process in operation 411. The operation of clearing the selected process by the process clearing module 330 according to various embodiments of the present disclosure, will be described with reference to FIGS. 6A and 6B.

FIGS. 6A and 6B are flowcharts illustrating a method of clearing a process using a process list to be cleared in an electronic device according to an embodiment of the present disclosure.

Referring to FIG. 6A, the process clearing module 330 may search all the present processes to select a process having the lowest priority based on the amount of the allocated memory in operation 601.

Thereafter the process clearing module 330 may select a process by determining the priority of the present processes in operation 603. The process clearing module 330 may determine the number of selected processes having the lowest priority in operation 605. When the number of selected processes having the lowest priority is larger than 1, the process clearing module 330 may select a process having the lowest priority according to the amount of the memory in operation 607. The process clearing module 330 may select a process occupying the maximum amount of the memory. Meanwhile, when the number of selected processes having the lowest priority is smaller than or equal to 1, the process clearing module 330 may directly configure (e.g., select) the process having the lowest priority in operation 615.

Referring to FIG. 6B, the process clearing module 330 may determine whether the number of selected processes reaches a set process upper threshold value in operation 609, and if so, may add the selected processes to a process list to be cleared in operation 611. Meanwhile, if not, the process clearing module 330 may determine whether the amount of the memory accommodated by the selected processes corresponds to the predicted amount of the memory in operation 612. If so, the process clearing module 330 may add the selected processes to the process list to be cleared in operation 611, and the operation flow may return to FIG. 4. Meanwhile, if not, the process clearing module 330 may search processes other than the selected processes among all the present processes in order to select a process having the lowest priority in operation 613, and may return to operation 605.

According to the embodiment, the idle memory corresponding to the amount of the allocated memory can be obtained by clearing all processes from the process list to be cleared in operation 411.

That is, the idle memory can be obtained by killing, at one time, all the processes in the process list to be cleared, and releasing the amount of the memory accommodated by the killed processes such that it corresponds to the predicted amount of the memory.

Thus, according to operations 401 to 411 described above, more idle memory can be obtained to correspond to the predicted amount of the memory, by calculating the amount of the memory allocated for the preset time period, predicting the amount of the memory to be allocated for the future setting time period based on the amount of the allocated memory, and selecting and clearing the arbitrary processes in the system based on the amount of the memory to be allocated.

In the above description, after all the processes in the process list to be cleared are killed at one time, all the processes recorded in the process list to be cleared may be preferably cleared.

The method of clearing the process may include calculating the amount of the memory allocated for the preset time period when the memory application is requested; predicting the amount of the memory to be allocated for the future setting time period based on the calculated amount of the allocated memory; and, selecting and clearing at least one of the present processes based on the amount of the memory to be allocated.

The result of the comparison between the process clearing method according to the embodiment of the present disclosure and the process clearing method according to the related art may be represented as in Table 1 below.

TABLE 1

| | | | Process Clearing |
|---|---|---|---|
| | | Process Clearing | Method according to |
| | | Method according to | Present disclosure |
| | | Related Art | illustrated in FIG. 4 |
| Memory | Total | 1780 MB | 1780 MB |
| Condition | Memory | | |
| Memory | Used | 415 MB | 387 MB |
| Condition | Memory | | |
| Memory | Rate of Used | 23% | 22% |
| Condition | Memory | | |
| Sluggish Test | Number of | 12 | 5 |
| | Killed | | |
| | Processes | | |

It can be seen from the result illustrated in Table 1 that, as compared with the existing process clearing method, the number of processes killed by the system is considerably decreased (e.g., from 12 to 5), and the amount of the memory used by the system is reduced a little by using the present disclosure under the same condition. Verification results for a plurality of performance indices using the sluggish script show that the method according to the present disclosure does not exert significant negative influences on other performance indices of the platform.

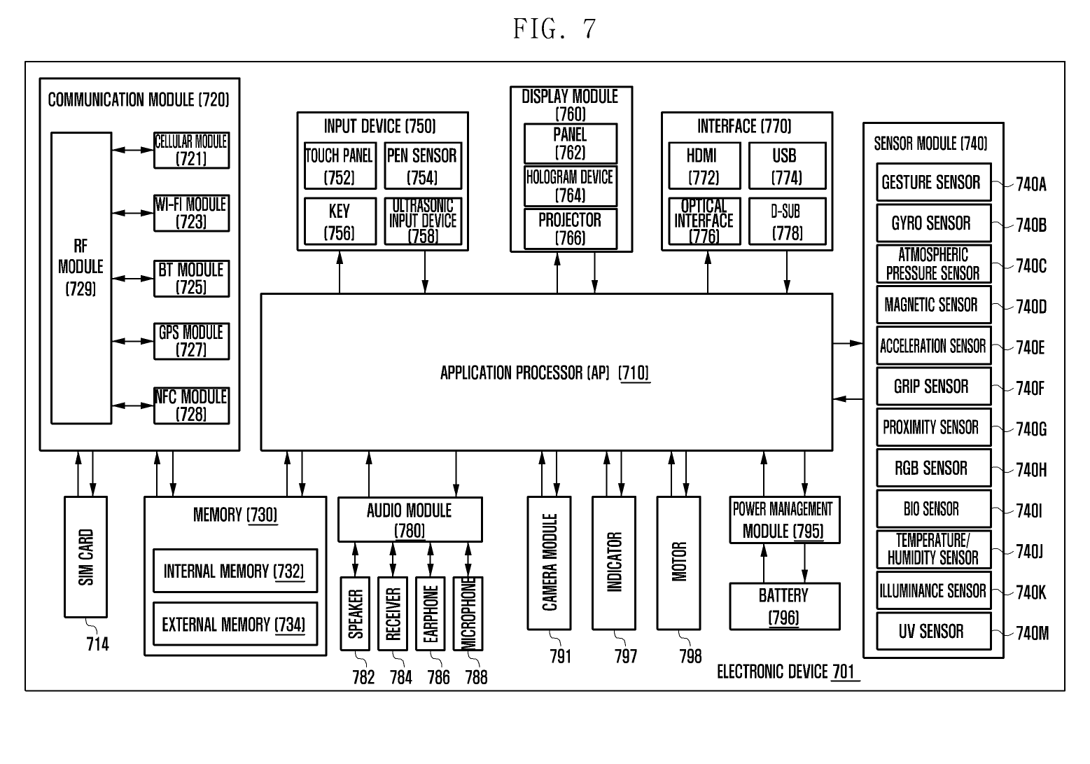

FIG. 7 is a block diagram of an electronic device 701 according to an embodiment of the present disclosure. The electronic device 701 may include, for example, all or some of the electronic device 201 illustrated in FIG. 2. Referring to FIG. 7, the electronic device 701 may include at least one Application Processor (AP) 710, a communication module 720, a Subscriber Identifier Module (SIM) card 714, a memory 730, a sensor module 740, an input device 750, a display module 760, an interface 770, an audio module 780, a camera module 791, a power management module 795, a battery 796, an indicator 797, and a motor 798.

The AP 710 may control a plurality of hardware or software components connected to the AP 710 by driving an operating system or an application program, and may process various data including multimedia data, and perform predictions. The AP 710 may be implemented by, for example, a System on Chip (SoC). According to an embodiment, the AP 710 may further include a Graphic Processing Unit (GPU).

The communication module 720 (e.g., the communication interface 260) may perform data transmission/reception in communication between the electronic device 701 (e.g., the electronic device 201) and other electronic devices (e.g., the electronic device 204 and the server 206) connected thereto through a network. According to an embodiment, the communication module 720 may include a cellular module 721, a Wi-Fi module 723, a BT module 725, a GPS module 727, an NFC module 728, and a Radio Frequency (RF) module 729.

The cellular module 721 may provide a voice call, a video call, a SMS, or an Internet service through a communication network (e.g., LTE, LTE-A, CDMA, WCDMA, UMTS, WiBro, or GSM). Furthermore, the cellular module 721 may distinguish and authenticate electronic devices within a communication network using, for example, a subscriber identification module (for example, the SIM card 724). According to an embodiment, the cellular module 721 may perform at least some functions which can be provided by the AP 710. For example, the cellular module 721 may perform at least some of the multimedia control functions.

According to an embodiment, the cellular module 721 may include a Communication Processor (CP). Furthermore, the cellular module 721 may be implemented by, for example, an SoC. Although the elements such as the cellular module 721 (e.g., a communication processor), the memory 730, and the power management module 795 are illustrated to be separate from the AP 710 in FIG. 7, the AP 710 may include at least some of the aforementioned elements (e.g., the cellular module 721) in an embodiment.

According to an embodiment, the AP 710 or the cellular module 721 (e.g., communication processor) may load a command or data received from at least one of a non-volatile memory and other elements connected thereto in a volatile memory, and may process the loaded command or data. Furthermore, the AP 710 or the cellular module 721 may store data received from or generated by at least one of other elements in a non-volatile memory.

The Wi-Fi module 723, the BT module 725, the GPS module 727, and the NFC module 728 may include, for example, a processor for processing data transmitted/received through the corresponding module. Although the cellular module 721, the Wi-Fi module 723, the BT module 725, the GPS module 727, and the NFC module 728 are illustrated as separate blocks in FIG. 7, at least some (for example, two or more) of the cellular module 721, the Wi-Fi module 723, the BT module 725, the GPS module 727, and the NFC module 728 may be included in one Integrated Chip (IC) or one IC package in one embodiment. For example, at least some (e.g., the communication processor corresponding to the cellular module 721 and the Wi-Fi processor corresponding to the Wi-Fi module 723) of the processors corresponding to the cellular module 721, the Wi-Fi module 723, the BT module 725, the GPS module 727, and the NFC module 728 may be implemented by one SoC.

The RF module 729 may transmit/receive data, for example, an RF signal. Although not illustrated, the RF unit 729 may include, for example, a transceiver, a Power Amp Module (PAM), a frequency filter, a Low Noise Amplifier (LNA), or the like. Furthermore, the RF module 729 may further include a component for transmitting/receiving electronic waves over a free air space in wireless communication, for example, a conductor, a conducting wire or the like. Although the cellular module 721, the Wi-Fi module 723, the BT module 725, the GPS module 727, and the NFC module 728 share one RF module 729 in FIG. 7, at least one of the cellular module 721, the Wi-Fi module 723, the BT module 725, the GPS module 727, and the NFC module 728 may transmit/receive an RF signal through a separate RF module in one embodiment.

The SIM card 714 may be a card including a subscriber identification module, and may be inserted into a slot formed in a particular portion of the electronic device. The SIM card 714 may include unique identification information (for example, an Integrated Circuit Card IDentifier (ICCID)) or subscriber information (for example, International Mobile Subscriber Identity (IMSI)).

The memory 730 (e.g., the memory 230) may include an internal memory 732 or an external memory 734. The internal memory 732 may include, for example, at least one of a volatile memory (e.g., a Dynamic RAM (DRAM), a Static RAM (SRAM), a Synchronous Dynamic RAM (SDRAM), and the like), and a non-volatile Memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, an NOR flash memory, and the like).

According to an embodiment, the internal memory 732 may be a Solid State Drive (SSD). The external memory 734 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 734 may be functionally connected with the electronic device 701 through various interfaces. According to an embodiment, the electronic device 701 may further include a storage device (or storage medium) such as a hard drive.

The sensor module 740 may measure a physical quantity or detect an operation state of the electronic device 701, and may convert the measured or detected information to an electronic signal. The sensor module 740 may include at least one of, for example, a gesture sensor 740A, a gyro sensor 740B, an atmospheric pressure sensor 740C, a magnetic sensor 740D, an acceleration sensor 740E, a grip sensor 740F, a proximity sensor 740G, a color sensor 740H (for example, red, green, and blue (RGB) sensor), a bio-sensor 740I, a temperature/humidity sensor 740J, an illumination sensor 740K, and a Ultra Violet (UV) sensor 740M. Additionally or alternatively, the sensor module 740 may include, for example, an E-nose sensor (not illustrated), an Electro Myo Graphy (EMG) sensor (not illustrated), an Electro Encephalo Gram (EEG) sensor (not illustrated), an Electro Cardio Gram (ECG) sensor (not illustrated), an Infrared (IR) sensor, an iris sensor (not illustrated), a fingerprint sensor, and the like. The sensor module 740 may further include a control circuit for controlling one or more sensors included therein.

The input device 750 may include a touch panel 752, a (digital) pen sensor 754, a key 756, or an ultrasonic input device 758. The touch panel 752 may recognize a touch input through at least one of a capacitive type, a resistive type, an infrared type, and an acoustic wave type. The touch panel 752 may further include a control circuit. The capacitive type touch panel may recognize physical contact or proximity. The touch panel 752 may further include a tactile layer. In this case, the touch panel 752 may provide a tactile reaction to the user.

The (digital) pen sensor 754 may be implemented, for example, using a method identical or similar to a method of receiving a touch input of the user, or using a separate recognition sheet. The key 756 may include, for example, a physical button, an optical key, or a keypad. The ultrasonic input device 758 may identify data by detecting an acoustic wave with a microphone (e.g., microphone 788) of the electronic device 701 through an input unit generating an ultrasonic signal, and may perform wireless recognition. According to an embodiment, the electronic device 701 may receive a user input from an external device (for example, computer or server) connected thereto using the communication module 720.

The display module 760 (e.g. the display 250) may include a panel 762, a hologram device 764, or a projector 766. The panel 762 may be, for example, a Liquid Crystal Display (LCD) or an Active Matrix Organic Light Emitting Diode (AM-OLED). The panel 762 may be implemented to be, for example, flexible, transparent, or wearable. The panel 762 may be configured by the touch panel 752 and one module. The hologram device 764 may show a stereoscopic image in the air using interference of light. The projector 766 may project light on a screen to display an image. The screen may be located, for example, inside or outside the electronic device 701. According to an embodiment, the display module 760 may further include a control circuit for controlling the panel 762, the hologram device 764, or the projector 766.

The interface 770 may include, for example, a High-Definition Multimedia Interface (HDMI) 772, a Universal Serial Bus (USB) 774, an optical interface 776, or a D-subminiature (D-sub) 778. The interface 770 may be included in, for example, the communication interface 260 illustrated in FIG. 2. Additionally or alternatively, the interface 770 may include, for example, a Mobile High-definition Link (MHL) interface, a Secure Digital (SD) card/Multi-Media Card (MMC) interface, or an Infrared Data Association (IrDA) standard interface.

The audio module 780 may bilaterally convert a sound and an electronic signal. At least some elements of the audio module 780 may be included in, for example, the input/output interface 240 illustrated in FIG. 2. The audio module 780 may process sound information input or output through, for example, the speaker 782, the receiver 784, the earphones 786, the microphone 788 or the like.

The camera module 791 is a device for capturing a still image or a video, and according to an embodiment, may include one or more image sensors (e.g., a front sensor or a rear sensor), a lens (not illustrated), an Image Signal Processor (ISP) (not illustrated), or a flash (not illustrated) (e.g., a Light Emitting Diode (LED) or xenon lamp).

The power managing module 795 may manage power of the electronic device 701. Although not illustrated, the power management module 795 may include, for example, a Power Management Integrated Circuit (PMIC), a charger Integrated Circuit (IC), or a battery or fuel gauge.

The PMIC may be mounted in, for example, an integrated circuit or an SoC semiconductor. Charging methods may be classified into a wired charging method and a wireless charging method. The charger IC may charge a battery and may prevent over voltage or over current from being introduced from a charger. According to an embodiment, the charger IC may include a charger IC for at least one of the wired charging method and the wireless charging method. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added.

The battery gauge may measure, for example, a remaining quantity of the battery 796, or a voltage, a current, or a temperature during the charging. The battery 796 may store or generate electricity, and may supply power to the electronic device 701 using the stored or generated electricity. The battery 796 may include, for example, a rechargeable battery or a solar battery.

The indicator 797 may display a specific status of the electronic device 701 or a part (e.g., the AP 710) of electronic device, for example, a booting status, a message status, a charging status, and the like. The motor 798 may convert an electrical signal to a mechanical vibration. Although not illustrated, the electronic device 701 may include a processing unit (e.g., GPU) for supporting a mobile TV. The processing unit for supporting a mobile TV can process media data according to a standard of Digital Multimedia Broadcasting (DMB), Digital Video Broadcasting (DVB), media flow, or the like.

The aforementioned elements of the electronic device according to various embodiments of the present disclosure may be configured with one or more components, and the name of the corresponding element may vary depending on a type of the electronic device. The electronic device according to the various embodiments of the present disclosure may include at least one of the aforementioned elements or may further include other additional elements, or some of the aforementioned elements may be omitted. Also, a few of component elements of an electronic device according to various embodiments of the present disclosure are coupled to form a single entity, and may equivalently execute functions of the corresponding component elements which are not coupled.

The “module” used in various embodiments of the present disclosure may refer to, for example, a “unit” including one of hardware, software, and firmware, or a combination of two or more of the hardware, software, and firmware. The “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” according to various embodiments of the present disclosure may include at least one of an Application-Specific Integrated Circuit (ASIC) chip, a Field-Programmable Gate Arrays (FPGAs), and a programmable-logic device for performing operations which have been known or are to be developed hereafter.

According to various embodiments, at least part of a device (for example, modules or functions thereof) or a method (for example, operations) according to the various embodiments of the present disclosure may be embodied by, for example, an instruction stored in a non-transitory computer readable storage medium provided in a form of a programming module. When the command is executed by one or more processors (for example, processor 222), the one or more processors may perform a function corresponding to the command. The non-transitory computer readable storage medium may be, for example, the memory 230. At least a part of the programming module may be implemented (for example, executed) by, for example, the processor 220. At least a part of the programming module may include, for example, a module, a program, a routine, a set of instructions and/or a process for performing one or more functions.

The non-transitory computer readable recording medium may include magnetic media such as a hard disk, a floppy disk, and a magnetic tape, optical media such as a Compact Disc Read Only Memory (CD-ROM) and a DVD, magneto-optical media such as a floptical disk, and hardware devices specially configured to store and perform a program instruction (for example, programming module), such as a Read Only Memory (ROM), a Random Access Memory (RAM), a flash memory and the like.

Further, the program commands may include high class language codes that can be executed in a computer by using an interpreter, as well as machine language codes that are made by a compiler. The aforementioned hardware device may be configured to operate as one or more software modules in order to perform the operation of the present disclosure, and vice versa. A programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Also, a few operations may be executed based on a different order, may be omitted, or may additionally include another operation.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of clearing a process, the method comprising:
calculating an amount of memory allocated for a preset time period, when a memory application is requested;
predicting an amount of memory to be allocated for a future setting time period based on the amount of the memory; and
selecting and clearing at least one of present processes based on the amount of the memory to be allocated.

2. The method of claim 1, wherein the calculating of the amount of the memory allocated for the preset time period comprises:
calculating an amount of memory first allocated for a recent setting time period;
determining a presence or absence of at least one time period in the recent setting time period for which the memory is not allocated;
predicting a time period for which the memory is allocated when there is not the at least one time period for which the memory is not allocated; and
calculating an amount of the memory allocated for the time period.

3. The method of claim 2, wherein the determining of the presence or absence of at least one time period in the recent setting time period for which the memory is not allocated comprises:
configuring the time period in the recent setting time period for which the memory is not allocated as a present time period, and the recent setting time period as a present setting time period when there is the time period for which the memory is not allocated.

4. The method of claim 1, wherein the calculating of the amount of the memory allocated for the preset time period comprises:
excluding the present time period from the present setting time period, and replacing the present time period by a recent time period;
determining whether there is still the time period for which the memory is not allocated; and
configuring the time period in the recent setting time period for which the memory is not allocated as the present time period, when there is the time period for which the memory is not allocated.

5. The method of claim 1, wherein the predicting of the amount of the memory to be allocated for the future setting time period comprises:
predicting the amount of the memory to be allocated for the future setting time period based on an amount of memory allocated according to a linear prediction manner.

6. The method of claim 1, wherein the predicting of the amount of the memory to be allocated for the future setting time period comprises:
predicting the amount of the memory to be allocated for the future setting time period based on an amount of memory allocated according to a non-linear prediction manner.

7. The method of claim 1, wherein the selecting and clearing of the at least one of the present processes comprises:
adding the selected process to a process list to be cleared, when the number of selected processes is larger than a threshold value; and
clearing all processes from the process list to be cleared.

8. The method of claim 7, wherein the clearing of the selected processes comprises:
searching the present processes;
selecting a process having the lowest priority among the searched processes, and determining the number of selected processes; and
selecting the process having the lowest priority according to the amount of the memory when the number of selected processes is larger than 1, and selecting the process having the lowest priority, when the number of selected processes is smaller than or equal to 1.

9. The method of claim 8, wherein the clearing of the selected processes further comprises:
determining whether an amount of memory accommodated by the selected processes corresponds to the predicted amount of the memory; and
adding the selected processes to the process list to be cleared when the amount of the memory accommodated by the selected processes corresponds to the predicted amount of the memory, and searching other processes when the amount of the memory accommodated by the selected processes does not correspond to the predicted amount of the memory.

10. The method of claim 7, wherein the clearing of the selected processes comprises:
killing, at one time, all the processes in the process list to be cleared such that an amount of memory accommodated by the cleared processes corresponds to the predicted amount of the memory.

11. A non-transitory computer readable recording medium having a program recorded thereon to implement the method of claim 1.

12. A device for clearing a process, the device comprising:
a memory calculating module configured to calculate an amount of memory allocated for a preset time period when a memory application is requested;
a memory predicting module configured to predict an amount of memory to be allocated for a future setting time period based on the amount of the allocated memory calculated by the memory calculating module; and
a process clearing module configured to select and clear at least one of all present processes based on the amount of the memory to be allocated.

13. The device of claim 12, wherein the memory calculating module is configured to calculate an amount of memory first allocated for a recent setting time period, to determine a presence or absence of at least one time period in the recent setting time period for which the memory is not allocated, and when there is not the at least one time period for which the memory is not allocated, to predict a time period for which the memory is allocated to calculate an amount of the memory allocated for the time period.

14. The device of claim 13, wherein the memory calculating module, when it is determined that there is the time period for which the memory is not allocated, is configured to configure the time period in the recent setting time period for which the memory is not allocated as a present time period and the recent setting time period as a present setting time period.

15. The device of claim 14, wherein the memory calculating module is configured to remove the present time period from the present setting time period, to replace the present time period by a recent time period, to determine whether there is still the time period for which the memory is not allocated, and when there is the time period for which the memory is not allocated, to configure the time period in the recent setting time period for which the memory is not allocated as the present time period.

16. The device of claim 12, wherein the memory predicting module is configured to predict the amount of the memory to be allocated for the future setting time period based on an amount of memory allocated according to a linear prediction manner, to predict the amount of the memory to be allocated for the future setting time period based on an amount of memory allocated according to a non-linear prediction manner.

17. The device of claim 12, wherein the process clearing module is configured to add the selected process to a process list to be cleared, and when the number of selected processes is larger than a threshold value, to clear all processes from the process list to be cleared.

18. The device of claim 17, wherein the process clearing module is configured to search the present processes, to select a process having the lowest priority, to determine the number of selected processes, and to select the process having the lowest priority according to the amount of the memory when the number of selected processes is larger than 1 and the process having the lowest priority when the number of selected processes is smaller than or equal to 1.

19. The device of claim 17, wherein the process clearing module is configured to determine whether an amount of memory accommodated by the selected processes corresponds to the predicted amount of the memory, to add the selected processes to the process list to be cleared when the amount of the memory accommodated by the selected processes corresponds to the predicted amount of the memory, and to search other processes when the amount of the memory accommodated by the selected processes does not correspond to the predicted amount of the memory.

20. The device of claim 17, wherein the process clearing module is configured to kill, at one time, all the processes in the process list to be cleared such that an amount of memory accommodated by the cleared processes corresponds to the predicted amount of the memory.
